(19) United States
(12) Patent Application Publication
(10) Pub. No.: US 2017/0222411 A1
(43) Pub. Date: Aug. 3, 2017

(54) Electrical Conductor and Method of Making the Same

(71) Applicant: OneSubsea IP UK Limited, London (GB)

(72) Inventor: Jean-Francois Noel, Soreidgrend (NO)

(73) Assignee: OneSubsea IP UK Limited, London (GB)

(21) Appl. No.: 15/011,381

(22) Filed: Jan. 29, 2016

(51) Int. Cl. H02G 3/04; E21B 17/02; H01B 13/00; H01B 1/14; H01B 3/08

(52) U.S. Cl. CPC H02G 3/0412; H01B 1/14; H01B 3/08; H01B 13/0016; E21B 17/028

(57) ABSTRACT

A conductive device includes a housing, a glass insulator, and a conductor. The housing comprises an opening. The glass insulator is located within the opening, wherein a seal is formed between the housing and the glass insulator. The conductor is located at least partially within the glass insulator and comprises at least one of conductive ceramic, cemented carbide, and cermet. A seal is formed between the glass insulator and the conductor.

### BACKGROUND

This section is intended to introduce the reader to various aspects of art that may be related to various aspects of the presently described embodiments. This discussion is believed to be helpful in providing the reader with background information to facilitate a better understanding of the various aspects of the described embodiments. Accordingly, it should be understood that these statements are to be read in this light and not as admissions of prior art.

The oil production industry has to contend with some of the most inhospitable conditions anywhere. These include thermal shock, high pressures, highly corrosive, abrasive environments, and wide temperature variations that may range between about −46° C., such as when in the vicinity of the choke and/or when in use in colder environments (e.g., Alaska), up to about 205° C. when downhole or for steam assisted gravity drainage (SAGD) applications. A further, and frequently major, factor is mechanical shock and fatigue due to vibration caused by fluid flow.

While oil and gas industry is among the most demanding applications for equipment such as sensors and connectors, other industries like weaponry, gas turbines, jet engines, and the nuclear industry also have very high specification requirements for sensors and connectors. In all of these industries, electrical conductors, such as feedthroughs or electrodes, need to show high corrosion resistance, high temperature resistance, and high pressure bearing capacity. Further, domains like medical applications, while potentially not as demanding as the latter applications, instead require very high standards for chemical compounds or materials that are used within the conductor design.

Several technologies are available that are incorporated into the design of electrical conductors. For example, a technique consists of including a metal pin within a polyether ether ketone (PEEK) insulator and a metal housing with the conductor sealed using O-rings. However, with this design, the O-rings are limited in terms of chemicals that are compatible with the O-rings, the minimum and maximum temperatures to which the O-rings are exposed, and use within rapid gas decompression applications. Further, PEEK materials have a rather low glass transition temperature, typically about 150° C., which leads to creep deformation complications for long term use at high temperatures.

Another example of electrical conductor includes a metal pin positioned within a ceramic insulator and a metal housing, in which the conductor is sealed by wetting braze material on both metal and ceramic parts of conductor. In this example, brazing requires wetability of the surfaces, which often requires a coating to be applied on the ceramic or the metal. This coating may be susceptible to corrosion. Further, brazing does not generate compression stresses into the ceramic/glass and may instead generate stress concentrations, which reduces the pressure bearing capacity of the ceramic. Furthermore, the brazing material is usually not bio-compatible, and therefore not suitable for medical applications, and also not corrosion resistant enough for long term service in a corrosive environment, such as found oil and gas or any other of the harsh environment applications mentioned above.

Conductors are also often made of Nickel-Cobalt-Ferrous alloys or Molybdenum low alloys because of their low thermal expansion properties. However, these metals or metallic alloys may not be corrosion resistant enough in extreme environments. Alternatively conductors made of highly corrosion resistant alloys can be used but these alloys generally have high thermal expansion coefficients which may be too high to achieve proper sealing or high pressure ratings needed for such devices.

### BRIEF DESCRIPTION OF THE DRAWINGS

For a detailed description of the embodiments of the invention, reference will now be made to the accompanying drawings in which:

FIG. 1A depicts a perspective view of a conductive device, in accordance with example embodiments;

FIG. 1B depicts a cross-sectional view of the conductive device, in accordance with example embodiments;

FIG. 2 is a diagrammatical view of an embodiment of the conductive device, in accordance with example embodiments;

FIG. 3 is a diagrammatical view of another embodiment of the conductive device, in accordance with example embodiments;

FIG. 4 is a diagrammatical view of another embodiment of the conductive device, in accordance with example embodiments; and

FIG. 5 is a diagrammatical view of another embodiment of the conductive device, in accordance with example embodiments.

### DETAILED DESCRIPTION

A conductive device in accordance with one or more embodiments may be used as a sensor to measure fluids or gas properties, such as in an adverse environment where high pressure, high temperature, and/or corrosive media need to be separated across sides of the sensor. For example, an electrical conductor may be used as an antenna or to gather a conductivity measurement. The conductive device may also be used as an electrical feedthrough to transfer data or power through such adverse environment where high pressure, high temperature, or corrosive media need to be separated across sides of the feedthrough. For example, the conductive device in accordance with one or more embodiments may be used as a connector in downhole application or on Christmas trees (e.g., production trees) as a redundant or wetted process barrier. The conductive device may be designed to isolate two regions of different pressure, such as withstanding a high pressure zone and ensuring integrity of a low pressure zone.

The conductive device may be able to sustain high differential pressure and high temperature, and may also be corrosion resistant such that the design enables the conductor to be made from or include non-metallic material, such as ceramic, cermet, or cemented carbide. For example, one or more embodiments in may be capable of being used within a high-pressure and/or high-temperature environment, which may be defined as a well having an undisturbed bottom hole temperature of greater than 177° C. or a pore pressure of at least 103 MPa.

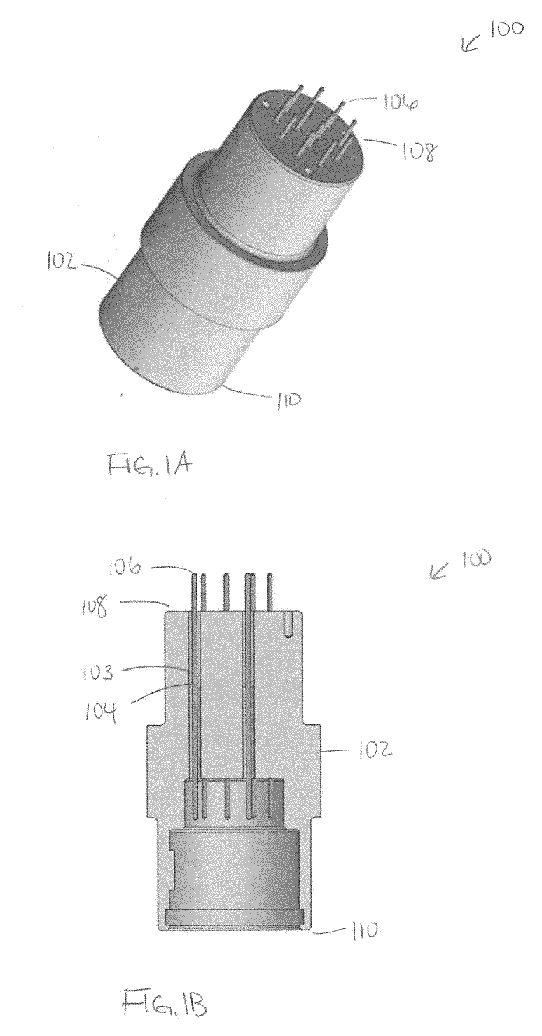

Referring to the drawings, FIG. 1A depicts a perspective view of a conductive device 100, in accordance with example embodiments. FIG. 1B depicts a cross-sectional view of the same. The conductive device 100 includes a housing 102 comprising one or more openings 103 or holes formed axially therethrough. The conductive device 100 further includes an insulator 104 located within the one or more openings 103 and one or more conductors 106 located at least partially within the insulator 104. The conductive device 100 has a first end 108 and a second end 110. In one or more embodiments, the conductors 106 are exposed at least at the first end 108.

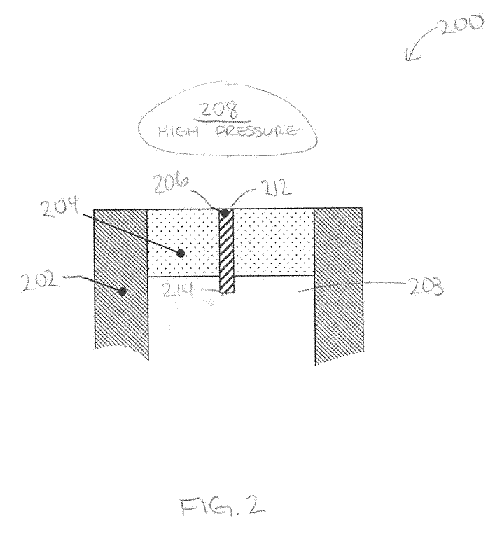

FIG. 2 depicts a detailed cross-sectional view of a first end of an example conductive device 200, in accordance with example embodiments Similar to the conductive device 100 of FIGS. 1A and 1B, conductive device 200 includes a housing 202, an insulator 204 located at least partially within the housing 202, and a conductor 206 located at least partially within the insulator 204. Only one conductor 206 is shown but the conductive device 200 can include a plurality of conductors 206, each located at least partially within the insulator 204 or within individual insulators. In one or more embodiments, a pressure tight seal is formed between the housing 202 and the insulator 204 via compression of the housing 202 onto the insulator 204. A pressure tight seal may also be formed between the insulator 204 and the conductor 206 via compression of the insulator 204 onto the conductor 206. As discussed below, the device 200 may be formed such that the housing 202 applies a compressional force onto the insulator 204 which applies a compressional force onto the conductor, thereby providing the pressure tight seals, which increases resistance of the device 200 against a high pressure region 208.

In one or more embodiments, the material of the housing 202 may have a thermal expansion coefficient greater than that of the material of the insulator 204. The material of the insulator may have a thermal expansion coefficient greater than that of the material of the conductor 206. The material of the insulator 204 may become deformable or pliable at a lower temperature than the materials of the housing 202 and the conductor 206.

In one or more embodiments, the housing 202 is fabricated from a metal material such as a stainless steel or a corrosion resistant alloy. In one or more embodiments, the insulator 204 is fabricated from a glass material. Glass as an insulator has the advantage of providing a seal resistant to higher pressure and temperatures compared to most insulators. It also provides the capability to seal toward metals by compression when heated and cooled, instead of requiring a sealing interface. The glass used for sealing may be from the family of borosilicate glass because of its corrosion resistance quality, especially in acidic environment. However, in some embodiments, the insulator 204 may be fabricated from other materials such as like glass ceramics.

In one or more embodiments, criteria for selecting a material for the conductor 206 include having low resistivity to ensure good electrical conductivity, having sufficient resistance to corrosion, including environmental corrosion as well as galvanic corrosion. The conductor material also needs to have an appropriate thermal expansion coefficient relative to the insulator 204 such that the insulator 204 will compress onto the conductor 206. In one or more embodiments, the conductor is fabricated from electrically conductive ceramic, cemented carbide, cermet, any combination thereof, or the like.

The electrically conductive ceramic may include or be formed from boride, carbide, or nitride, and may also include or be formed from one or more metals selected from the group IV, V, and VI elements. For example, the conductor 206 may be made from or include titanium diboride (TiB₂)).

The cermet may be or include a binder, such as a heterogeneous combination of one or more metals or alloys binder, with one or more ceramic phases that may constitute between approximately 1% and 98% by volume and may include relatively little solubility between metallic and ceramic phases at the preparation temperature. The ceramic phase may be or include metallic oxide, boride, carbide, nitride, carbonitride, silicide, carbon (including diamond), or a mixture or compound of such materials. The metal binder may be or include a metal or a metallic alloy, such as containing mostly iron (Fe), nickel (Ni), cobalt (Co), manganese (Mn), molybdenum (Mo), chromium (Cr), tungsten (W), and/or titanium (Ti).

Cemented carbide typically includes a mix of metal and ceramic which combines their advantages. For example, if a carbide is chosen with a very low thermal expansion coefficient, cemented by a metallic alloy or metal, the thermal expansion coefficient can be tuned to be compatible with the thermal expansion coefficient of the insulator material by adjusting the ratio of carbide to cement. The thermal expansion coefficient criterion being satisfied, the type of cement can be chosen to have the appropriate environmental resistance and galvanic potential. An example cemented carbide is cemented tungsten carbide. Cemented cobalt carbide, cemented nickel carbide, and cemented titanium carbide may also be appropriate for many applications. Additionally, the cemented carbide may be or include a ceramic phase and/or a metal binder phase. The ceramic phase may be or include W, such as WB, tantalum (Ta), such as TaC, Ti, such as TiC, and niobium (Nb), such as NbC, or a mixture or compound of such materials, and the metal binder phase may be or include metal or a metallic alloy, such as containing Ni and/or Co.

A method of fabricating the conductive device 200 includes assembling the components of the conductive device 200. Assembling the components includes obtaining the housing 202 which has opening 203, inserting an insulator 204 into the opening 203, and inserting the conductor 206 into the insulator 204 such that the conductor 206 is electrically isolated from the housing 202. In one or more embodiments, the insulator is in the form of a tube (e.g., glass tube) when inserted into the housing 202. The outer diameter of the insulator may be sized to have an interference fit within the opening 203. Similarly, the outer diameter of the conductor 206 may be sized to fit snugly within the inner diameter of the insulator tube.

When the housing 202, insulator 204, and conductor 206 are assembled as such, the assembly is heated, thereby lowering the viscosity and increasing the pliability of the insulator 204 but not the housing 202 or conductor 206. When the insulator 204 becomes pliable, it may flow into and fill any crevices between the housing 202 and the conductor 206. The assembly is then cooled, bringing the insulator material back to a solid state.

Due to the relative thermal expansion coefficients between the housing 202, the insulator 204, and the conductor 206, when the assembly is cooled after heating, the housing 202 applies a compressional force onto the insulator 204, thereby forming a pressure seal therebetween. Similarly, the insulator 204 applies a compressional force onto the conductor 206, thereby forming a pressure seal therebetween. The compressional force between the housing 202 and the insulator 204 and between the insulator 204 and the conductor 206 increase the frictional grip between these components, thereby increasing integrity of the device 200 under high pressure conditions.

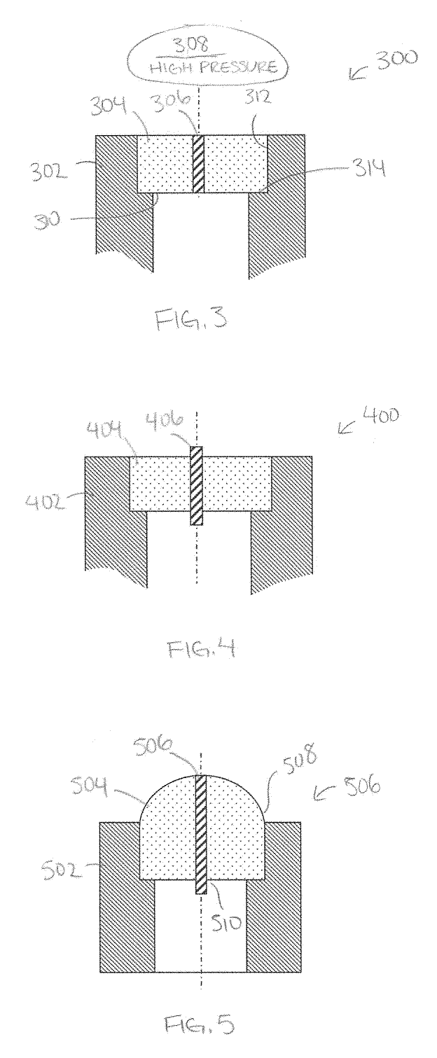

The conductive device 200 of FIG. 2 illustrates an embodiment in which the conductor 206 is flush with the insulator 204 at one end 212 and protrudes from the insulator 204 at another end 214. However, the conductor 206 and insulator 204 can be positioned relative to each other and to the housing 202 in a variety of different configurations. FIGS. 3-5 illustrate additional example embodiments of the conductive device, which represent non-limiting examples of connector or sensor types within the scope of the present disclosure. FIG. 3 depicts a conductive device 300 in which the conductor 306 is flush with the insulator 304 at both ends. FIG. 4 depicts a conductive device 400 in which the conductor 406 protrudes from the insulator 404 at both ends. FIG. 5 depicts a conductive device 500 in which the insulator 504 protrudes from the housing 502 at a first end 508, and in which the conductor 506 is flush with the insulator 504 at the first end 508 and protrudes from the insulator at a second end 510.

In one or more embodiments, such as that illustrated in FIG. 3, the housing 302 also includes a shoulder 314 which forms a surface having an inner opening smaller than the outer profile of the insulator 304 such that the insulator 304 is axially supported by the shoulder 314.

In one or more embodiments, the housing 302 may include an annular interfacing layer 310 disposed between the bottom edge of the insulator 304 and the shoulder 314. The interfacing layer 310 may be formed from or include a metal that is softer than the metal forming the housing 302 such that the interfacing layer 310 deforms slightly when a force is applied thereupon by the housing 302 or the insulator 304. Such deformation of the interfacing layer may enable the force applied be substantially uniform. The material of the interfacing layer may be softer than the ceramic and the hard metal used in the frame, but not so soft that the interfacing layer 310 flows out of the opening between the insulator 304 and the housing 302. A suitable material of the interfacing layer may include gold (Au), platinum (Pt), palladium (Pd), tantalum (Ta), iridium (Ir), and/or Ni.

In one or more embodiments, an annular interfacing layer 312 may also be included between the outer diameter of the insulator and the housing 302. The interfacing layer 312 may be formed from or include a metal that is softer than the metal forming the housing 302 such that the annular interfacing layer deforms slightly when subjected to the compressive force applied by the housing 302 or insulator 304. Such deformation of the interfacing layer may insure that the compressive force applied around the circumference of the insulator 304 is substantially uniform. Additionally, the interfacing layer 312 may provide further retention of the insulator 304 in response to fluid pressure applied to insulator 304 from the high pressure region 308.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

What is claimed is:

1. A conductive device, comprising:
a housing comprising an opening;
a glass insulator located within the opening, wherein a seal is formed between the housing and the glass insulator; and
a conductor located at least partially within the glass insulator and comprising at least one of conductive ceramic, cemented carbide, and cermet, wherein a seal is formed between the glass insulator and the conductor.

2. The device of claim 1, wherein the housing comprises a material comprising a thermal expansion coefficient greater than that of the glass insulator.

3. The device of claim 1, wherein the glass insulator comprises a material comprising a thermal expansion coefficient greater than that of the conductor.

4. The device of claim 1, wherein:
the glass insulator is compressed within the housing; and
the conductor is compressed within the glass insulator.

5. The device of claim 1, wherein the conductive ceramic comprises boride, barbide, nitride, any metal selected from group IV, V, and VI elements, or any combination thereof.

6. The device of claim 1, wherein the cermet comprises at least one of a heterogeneous metal combination and a heterogeneous alloy combination, and wherein the cermet further comprises at least one ceramic phase.

7. The device of claim 1, wherein the cemented carbide comprises:
a ceramic phase comprising at least one element of tungsten, tantalum, titanium, and niobium; and
a metallic binder phase comprising at least one of a metal or a metal alloy.

8. The device of claim 1, further comprising a plurality of conductors.

9. A conductive device, comprising:
a housing comprising an opening;
an insulator located within the opening, wherein a seal with formed between the housing and the insulator; and
a conductor located at least partially within the glass insulator,
wherein a seal is formed between the insulator and the conductor; and
wherein the insulator comprises a material having a thermal expansion coefficient greater than that of the conductor.

10. The device of claim 9, wherein the conductor comprises electrically conductive ceramic, cemented carbide, or cermet.

11. The device of claim 9, wherein the conductor is flush with the insulator at one or both ends.

12. The device of claim 9, wherein the conductor extends beyond the insulator at one or both ends.

13. The device of claim 9, wherein the insulator extends beyond the housing at one end.

14. The device of claim 9, wherein the housing comprises an annular shoulder configured to support at least a portion of the insulator.

15. The device of claim 9, wherein the insulator comprises a glass material.

16. A method of fabricating a conductive device, comprising:
inserting a glass insulator into an opening of a housing; and
inserting a conductor into the glass insulator, wherein the conductor comprises ceramic, cemented carbide, or cermet;
heating the assembled conductive device to lower the viscosity of the glass insulator; and
cooling the assembled conductive device to solidify the glass insulator.

17. The method of claim 13, wherein cooling the assembled conductive device further comprises forming a seal between the glass insulator and the conductor.

18. The method of claim 13, further comprising forming a seal between the housing and the glass insulator.

19. The method of claim 13, further comprising compressing the glass insulator and the conductor through expansion of the housing during the cooling.

20. The method of claim 13, wherein the conductor comprises any combination of boride, barbide, nitride, any metal selected from group IV, V, and VI elements, a heterogeneous metal combination and a heterogeneous alloy combination, a ceramic phase comprising at least one element of tungsten, tantalum, titanium, and niobium, and a metallic binder phase comprising at least one of a metal and a metal alloy
